(19) United States
(12) Patent Application Publication
(10) Pub. No.: US 2016/0150185 A1
(43) Pub. Date: May 26, 2016

(54) SWITCH SYSTEM FOR VIDEO CONFERENCE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: CHUN-SHENG CHEN, New Taipei (TW); YUAN TIAN, Wuhan (CN)

(21) Appl. No.: 14/584,650

(22) Filed: Dec. 29, 2014

(30) Foreign Application Priority Data
Nov. 24, 2014 (CN) 201410678585.2

(51) Int. Cl. H04N 7/15

(52) U.S. Cl. CPC H04N 7/15

(57) ABSTRACT

A switch system for video conference includes a video signal processing chip, an internal video interface, an external video interface, and a switch unit. The video signal processing chip includes a second GPIO pin and a third GIPO pin. The second GPIO pin and the third GIPO pin receive a first state signal and a second state signal. The video signal processing chip determines a mode of an electronic device according to voltage levels of the first state signal and the second state signal. When the video signal processing chip determines that the electronic device is in a working mode, the video signal processing chip receives an internal video source from the internal video interface. When the video signal processing chip determines that the electronic device is in a hibernate mode or a sleep mode, the video signal processing chip determines whether the internal video interface is cut off.

### CROSS-REFERENCE TO RELATED APPLICATIONS

This application claims priority to Chinese Patent Application No. 201410678585.2 filed on Nov. 24, 2014, the contents of which are incorporated by reference herein.

### FIELD

The subject matter herein generally relates to a switch system for a video conference.

### BACKGROUND

Conventional video conference systems only display the picture from an appointed video source when an external video source is connected to the video conference system. The video conference system cannot switch to the external video source and display the picture.

### BRIEF DESCRIPTION OF THE DRAWINGS

Implementations of the present technology will now be described, by way of example only, with reference to the attached figures.

FIG. 1 is a block diagram of an embodiment of a switch system for a video conference.

FIG. 2 is a circuit diagram of the switch system for the video conference of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

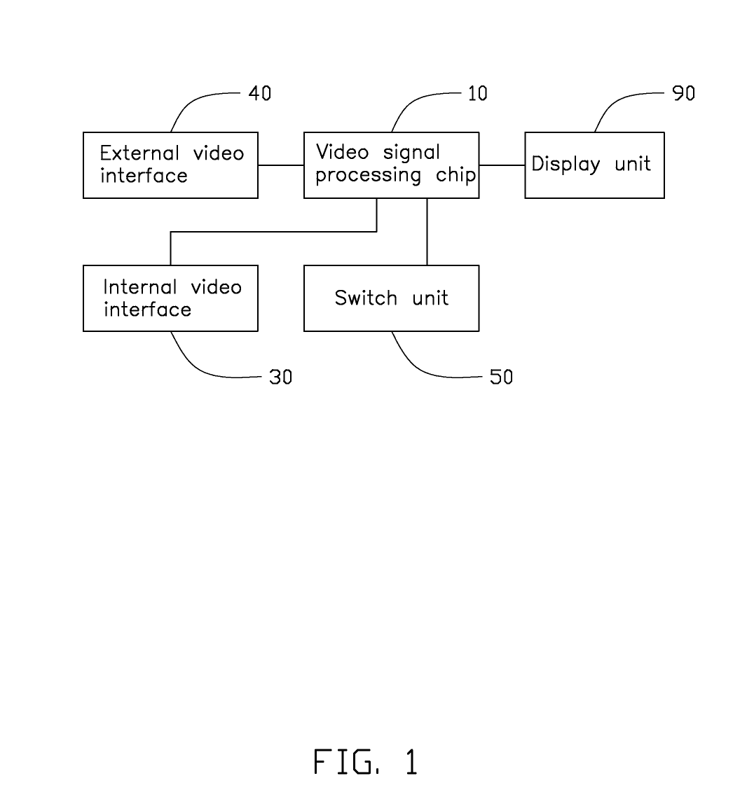

FIG. 1 illustrates a switch system for a video conference in accordance with an embodiment. The switch system includes a video signal processing chip 10, an internal video interface 30, an external video interface 40, a switch unit 50, and a display unit 90. The internal video interface 30, the external video interface 40, the switch unit 50, and the display unit 90 are electrically coupled to the video signal processing chip 10. The switch system can be used in an electronic device, for example, a fixed-line telephone or a mobile phone.

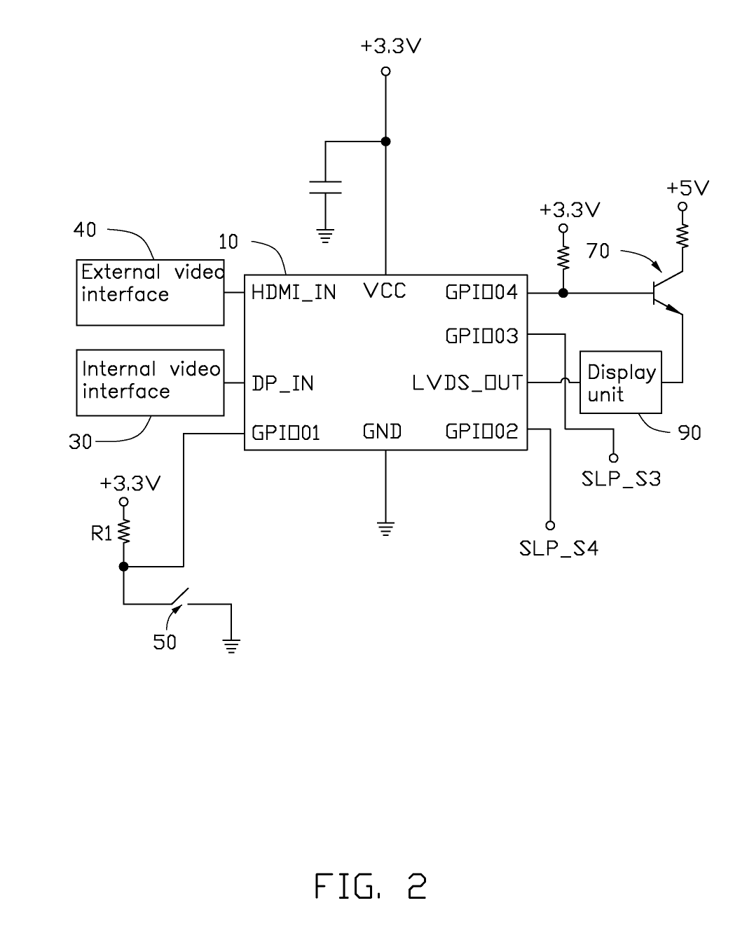

FIG. 2 illustrates that the video signal processing chip 10 includes a power pin Vcc, a high-definition multimedia interface (HDMI) signal input pin HDMI_IN, a display port (DP) signal input pin DP_IN, a first general purpose input output (GPIO) pin GPIO01, a second GPIO pin GPIO02, a third GIPO pin GPIO03, a fourth GPIO pin GPIO04, a low voltage differential signaling (LVDS) signal output pin LVDS_OUT, and a ground pin GND. The DP signal input pin DP_IN is electrically coupled to the internal video interface 30. The internal video interface 30 is used to input an internal video source. The HDMI signal input pin HDMI_IN is electrically coupled to the external video interface 40. The external video interface 40 is used to input an external video source. In one embodiment, the internal video interface 30 is a DP interface and is positioned in an inner side of the electronic device. The external video interface 40 is a HDMI port and is positioned in an outer side of the electronic device.

The power pin Vcc receives a +3.3 volts auxiliary voltage. The ground pin GND is grounded. The LVDS signal output pin LVDS_OUT is electrically coupled to the display unit 90. The display unit 90 receives a +5 volts auxiliary voltage via a transistor 70. The fourth GPIO pin GPIO04 is electrically coupled to a base of the transistor 70. An emitter of the transistor 70 is electrically coupled to the LVDS signal output pin LVDS_OUT via the display unit 90. A collector of the transistor 70 receives the +5 volts auxiliary voltage. The first GPIO pin GPIO01 is electrically coupled to the +3.3 volts auxiliary voltage via a resistor R. The first GPIO pin GPIO01 is electrically coupled to a first terminal of the switch unit 50. A second terminal of the switch unit 50 is grounded. The second GPIO pin GPIO02 and the third GIPO pin GPIO03 receives a first state signal SLP_S4 and a second state signal SLP_S3 from a platform controller hub (PCH) chip on a circuit board respectively. In one embodiment, the transistor 70 is an NPN type transistor. The display unit 90 is a LVDS panel.

In use, the video signal processing chip 10 determines a mode of the electronic device according to voltage levels of the first state signal SLP_S4 and the second state signal SLP_S3. When the voltage levels of the first state signal SLP_S4 and the second state signal SLP_S3 are both high voltage levels, the electronic device is in a working mode. When the voltage levels of the first state signal SLP_S4 and the second state signal SLP_S3 are both low voltage levels, the electronic device is in a hibernate mode. When the voltage level of the first state signal SLP_S4 is high voltage level and the voltage level of the second state signal SLP_S3 is low voltage level, the electronic device is in a sleep mode. When the video signal processing chip 10 determines that the electronic device is in the working mode, the video signal processing chip 10 receives the internal video source from the internal video interface 30.

When the video signal processing chip 10 determines that the electronic device is in hibernate mode or sleep mode, the video signal processing chip 10 turns off the display unit 90. The video signal processing chip 10 determines whether the internal video interface 30 is cut off. If the internal video interface 30 is cut off, the video signal processing chip 10 switches to receive the external video source from the external video interface 40. If the video signal processing chip 10 does not receive a external video source in a predetermined time, for example, in 10 seconds time, and the video signal processing chip 10 will switch back to the internal video interface 30, the video signal processing chip 10 turns off the display unit 90.

In use, the fourth GPIO pin GPIO04 outputs control signals to turn on or turn off the transistor 70. The display unit 90 receives the +5 volts auxiliary voltage when the transistor 70 turns on. When the switch unit 50 is open, the first GPIO pin GPIO01 receives the +3.3 volts auxiliary voltage and is at a high voltage level. When the switch unit 50 is closed, the first GPIO pin GPIO01 is grounded via the switch unit 50 and is at a low voltage level. The video signal processing chip 10 switches to the internal video interface 30 or the external video interface 40 according to the voltage level of the first GPIO pin GPIO01.

The embodiments shown and described above are only examples. Many details are often found in the art such as the other features of a switch system for video conference. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A switch system for a video conference, the switch system comprising:
a video signal processing chip comprising:
a high-definition multimedia interface (HDMI) signal input pin,
a display port (DP) signal input pin,
a first general purpose input output (GPIO) pin,
a second GPIO pin,
a third GIPO pin,
a fourth GPIO pin, and
a low voltage differential signaling (LVDS) signal output pin;
an internal video interface electrically coupled to the DP signal input pin;
an external video interface electrically coupled to the HDMI signal input pin;
a switch unit electrically coupled to the first GPIO pin; and
a display unit electrically coupled to the fourth GPIO pin and the LVDS signal output pin,
wherein the second GPIO pin and the third GIPO pin receive a first state signal and a second state signal respectively; the video signal processing chip determines a mode of an electronic device according to voltage levels of the first state signal and the second state signal;
wherein when the video signal processing chip determines that the electronic device is in a working mode, the video signal processing chip receives an internal video source from the internal video interface; and
wherein when the video signal processing chip determines that the electronic device is in a hibernate mode or a sleep mode, the video signal processing chip turns off the display unit, the video signal processing chip determines whether the internal video interface is cut off,
if the internal video interface is cut off, the video signal processing chip switches to receive an external video source from the external video interface; if the video signal processing chip does not receive any external video source in a predetermined time the video signal processing chip switches back to the internal video interface.

2. The switch system for the video conference of claim 1, wherein when the voltage levels of the first state signal and the second state signal are both high voltage levels, the electronic device is in the working mode.

3. The switch system for the video conference of claim 2, wherein when the voltage levels of the first state signal and the second state signal are both low voltage levels, the electronic device is in the hibernate mode.

4. The switch system for the video conference of claim 1, wherein when the voltage level of the first state signal is high voltage level and the voltage level of the second state signal is low voltage level, the electronic device is in the sleep mode.

5. The switch system for the video conference of claim 1, further comprising a transistor electrically coupled to the video signal processing chip and the display unit; the fourth GPIO pin is electrically coupled to a base of the transistor; an emitter of the transistor is electrically coupled to the LVDS signal output pin via the display unit; and a collector of the transistor receives a first auxiliary voltage.

6. The switch system for the video conference of claim 5, wherein the transistor is a npn type transistor; and the first auxiliary voltage is +5 volts.

7. The switch system for the video conference of claim 1, wherein the video signal processing chip further comprises a power pin; and the power pin receives a second auxiliary voltage.

8. The switch system for the video conference of claim 7, wherein the second auxiliary voltage is +3.3 volts.

9. The switch system for the video conference of claim 1, wherein the display unit is a LVDS panel; the internal video interface is positioned in an inner side of the electronic device; and the external video interface is positioned in an outer side of the electronic device.

10. A switch system for a video conference, the switch system comprising:
a video signal processing chip comprising:
a high-definition multimedia interface (HDMI) signal input pin,
a display port (DP) signal input pin,
a first general purpose input output (GPIO) pin,
a second GPIO pin, and
a third GIPO pin;
an internal video interface electrically coupled to the DP signal input pin;
an external video interface electrically coupled to the HDMI signal input pin; and
a switch unit electrically coupled to the first GPIO pin,
wherein the second GPIO pin and the third GIPO pin receive a first state signal and a second state signal respectively; the video signal processing chip determines a mode of an electronic device according to voltage levels of the first state signal and the second state signal;
wherein when the video signal processing chip determines that the electronic device is in a working mode, the video signal processing chip receives an internal video source from the internal video interface; and
wherein when the video signal processing chip determines that the electronic device is in a hibernate mode or a sleep mode, the video signal processing chip determines whether the internal video interface is cut off,
if the internal video interface is cut off, the video signal processing chip switches to receive an external video source from the external video interface; if the video signal processing chip does not receive any external video source in a predetermined time the video signal processing chip switches back to the internal video interface.

11. The switch system for the video conference of claim 10, wherein when the voltage levels of the first state signal and the second state signal are both high voltage levels, the electronic device is in the working mode.

12. The switch system for the video conference of claim 11, wherein when the voltage levels of the first state signal and the second state signal are both low voltage levels, the electronic device is in the hibernate mode.

13. The switch system for the video conference of claim 11, wherein when the voltage level of the first state signal is high voltage level and the voltage level of the second state signal is low voltage level, the electronic device is in the sleep mode.

14. The switch system for the video conference of claim 11, further comprising a transistor electrically coupled to the video signal processing chip; the video signal processing chip further comprises a fourth GPIO pin and a low voltage differential signaling (LVDS) signal output pin; the fourth GPIO pin is electrically coupled to a base of the transistor; an emitter of the transistor is electrically coupled to the LVDS signal output pin via a display unit; and a collector of the transistor receives a first auxiliary voltage.

15. The switch system for the video conference of claim 14, wherein the transistor is a npn type transistor; and the first auxiliary voltage is +5 volts.

16. The switch system for the video conference of claim 14, wherein the display unit is a LVDS panel; the internal video interface is positioned in an inner side of the electronic device; and the external video interface is positioned in an outer side of the electronic device.

17. The switch system for the video conference of claim 11, wherein the video signal processing chip further comprises a power pin; and the power pin receives a second auxiliary voltage.

18. The switch system for the video conference of claim 17, wherein the second auxiliary voltage is +3.3 volts.
